(19) United States
(12) Patent Application Publication
(10) Pub. No.: US 2020/0002137 A1
(43) Pub. Date: Jan. 2, 2020

(54) APPARATUS AND METHOD FOR CARRYING ELONGATE CONSTRUCTION ELEMENTS

(71) Applicant: PMH Technologies Pty Ltd, Warmambool, Victoria (AU)

(72) Inventors: David John HETHERINGTON, Warrnambool, Victoria (AU); Warren James GREENHALGH, Warrnambool, Victoria (AU)

(73) Assignee: PMH Technologies Pty Ltd, Warmambool, Victoria (AU)

(21) Appl. No.: 16/477,539

(22) PCT Filed: Jan. 12, 2018
(86) PCT No.: PCT/AU2018/050020

§ 371 Date: Jul. 12, 2019

(30) Foreign Application Priority Data
Jan. 13, 2017 (AU) 2017900098

(51) Int. Cl. B66C 1/12; B66C 1/14; B66F 9/18; B66F 9/065; B66C 23/42

(52) U.S. Cl. CPC B66C 1/125; B66C 1/14; B66C 23/42; B66F 9/0655; B66F 9/18

(57) ABSTRACT

Disclosed herein is an apparatus and method for carrying a plurality of elongate construction elements such as pipes. The apparatus comprises opposing side members and a joining member. Each of the side members is elongate in width and comprises one or more couplings and attachment points. The couplings are configured to receive thereat corresponding couplings of a lifting machine. The attachment points are spaced along the width of the side member and configured to receive construction element engaging members thereat. The joining member is between the side members and has a length that is adjustable to define a separation between the side members which corresponds to a length of the construction element.

### TECHNICAL FIELD

The present invention relates to an apparatus and method for carrying elongate construction elements. In one particular form, the present invention relates to an apparatus and method for carrying a plurality of pipes.

### BACKGROUND ART

It is frequently necessary to move elongate construction elements such as pipes and steel rods (e.g. merchant bars), beams, etc. from one location to another. Conventionally, lifting machines such as cranes lift these construction elements using specialised equipment which is specific for that element. In the case of pipes, for example, lifting machines such as cranes can lift pipes using pipe engaging members, which securely engage the pipes and provide attachment points for the crane's hook. Currently used pipe engaging members include slings wrapped around the pipe, or pipe hooks adapted to hook the pipe's opposing ends. Typically, these pipe engaging members either depend from a central location (e.g. a shackle) or from spaced apart locations on a spreader beam (or the like), with the crane's hook being attached the shackle or spreader beam in order to lift and carry the pipes.

Such cranes are non-travelling and are therefore conventionally used to unload the pipes (e.g. from a ship) and move them only a short distance (e.g. to the dockside). Once unloaded, the pipes are then typically picked up using forklifts fitted with pipe clamps, where the pipe clamp clamps a pipe around its centre, lifts the pipe off the ground and then transports the pipe to the location it is needed.

Whilst effective for lifting and carrying pipes, such conventional methods can, however, be time consuming and therefore significantly reduce the efficiency with which pipes can be transferred from one location to another. It would be advantageous to provide pipe lifting apparatus and methods that may help to increase the efficiency with which pipes (and similar elongate construction elements) can be transferred.

### SUMMARY OF INVENTION

In a first aspect, the present invention provides an apparatus for carrying a plurality of elongate construction elements (e.g. pipes etc., as will be described below). The apparatus comprises opposing side members and a joining member. Each of the side members is elongate in width and comprises one or more couplings and attachment points. The couplings are configured to receive thereat corresponding couplings of a lifting machine. The attachment points are spaced along the width of the side member and configured to receive construction element engaging members thereat. The joining member is between the side members and has a length that is adjustable to define a separation between the side members which corresponds to a length of the construction elements.

The present inventors recognised that existing apparatus for carrying elongate construction elements such as pipes etc. are somewhat ad hoc in their nature and construction. For example, the inventors noted that many apparatus for carrying pipes are capable only for use with a specific lifting machine and are not generally capable of use with other lifting machines. Furthermore, existing apparatus tend to be only capable of lifting one or perhaps two construction elements (e.g. pipes) at a time, regardless of their size. The apparatus of the present invention advantageously has couplings which can facilitate use of the apparatus with a number of different lifting machines (including, for example, cranes, reach stackers and top lifting forklifts, which are examples of lifting machines that are commonly used in conjunction with each other in cargo unloading environments). The arrangement (i.e. location, orientation and type) of couplings on the side members of the apparatus can be adapted for maximum compatibility with the coupling systems of lifting machines commonly used in specific environments.

Furthermore, the side members of the apparatus of the present invention may be configured to carry any practical number of construction elements, the elements having a wide variety of shapes and sizes. Many existing lifting apparatus are not capable of such diverse uses. Such advantageous features and functionality enable use of the apparatus to potentially improve the efficiency with which construction elements are transferred from one location to another.

Safety can also be improved when carrying pipes using the apparatus of the present invention, with the pipes (etc.) being handled at or near to their ends and not in the middle, as is the case for may conventional pipe-handling apparatus, and on the ground (i.e. not overhead). This arrangement can not only reduce the number of people required to carry and transport the pipes, but can be operated in a wider range of weather conditions than is possible if moving pipes by crane, for example (operation of cranes would usually be severely limited in windy conditions).

In some embodiments, the one or more couplings may comprise couplings spaced along the width of each side member. Providing each side member with a plurality of couplings configured in this manner may help to increase the strength and/or stability of the coupling. In some embodiments, the couplings may be located at opposing ends of the side members. Such positioning may be helpful in stabilising a heavy load of pipes or other construction elements, or may provide a configuration which is compatible with that of the relevant lifting machine(s).

In some embodiments, the couplings may each comprise a recess configured to receive a fastener of the lifting machine. The couplings may, for example, each comprise a corner casting configured to receive a twistlock of the lifting machine. Such couplings would be especially useful for coupling the apparatus to a reach stacker, for example, which often have spreaders with twistlock couplings because they are routinely used to carry shipping containers around cargo unloading environments.

Alternatively (or in addition), in some embodiments, the couplings may each comprise a lift lug (or lugs) configured to receive a respective fastener (e.g. a D-shackle) at an end of a chain. Such couplings would be advantageous, for example, where the apparatus is intended for lifting by a crane during the carrying of the construction elements. In some embodiments, the couplings may be configured for coupling to multiple lifting machines (e.g. the one or more couplings comprise both a corner casting configured to receive a twistlock of a lifting machine and a lift lug).

In some embodiments, the attachment points may be spaced along the width of a lower portion of each side member. In some embodiments, the attachment points may comprise apertures spread along the width of the side members (e.g. spread along the width of a lower portion of the side members). Such a distribution of attachment points may maximise the number of construction elements capable of being carried by the apparatus.

In some embodiments, the construction element engaging members may comprise slings configured to be wrapped around a construction element(s), each end of the slings being fastenable to a respective attachment point. In embodiments where the construction element is a pipe, the construction element engaging members may comprise hooks configured to hook opposing ends of a pipe, the pipe hooks being at one end of a chain and the distal end of the chain being attached to the attachment point.

In some embodiments, the joining member may comprise two overlapping members (e.g. beams having any suitable shape) that are slidable relative to each other.

In a second aspect, the present invention provides an apparatus for carrying a plurality of elongate construction elements (e.g. pipes etc.). The apparatus comprises opposing side members and a joining member. Each of the side members is elongate in width and comprises couplings and attachment points. The couplings are spaced along the width of the side member and configured to receive thereat corresponding couplings of a lifting machine. The attachment points are spaced along the width of the side member and configured to receive construction element engaging members thereat. The joining member is between the side members and has a length that is adjustable to define a separation between the side members which corresponds to a length of the construction element.

Other components of the apparatus of the present invention (and their attendant advantages) will be described in further detail below.

In a third aspect, the present invention provides a method for carrying a plurality of pipes (or other construction elements, as herein described). The method comprises:
coupling a lifting machine to an apparatus comprising:
   opposing side members, each side member being elongate in width and comprising:
      one or more couplings, each coupling being configured to receive thereat a corresponding coupling of the lifting machine; and
      attachment points comprising pipe engaging members spaced along the width of the side member, and
   a joining member between the side members, a length of the joining member being adjustable to define a separation between the side members which corresponds to a length of the pipes;
adjusting the length of the joining member to correspond to the length of the pipes, if necessary;
positioning the apparatus over the one or more pipes;
engaging the pipe engaging members with a respective pipe of the pipes; and
actuating the lifting machine to lift the apparatus and its dependent pipes.

In a fourth aspect, the present invention provides a method for carrying a plurality of pipes (or other construction elements, as herein described). The method comprises:
coupling a lifting machine to an apparatus that comprises:
   opposing side members, each side member being elongate in width and comprising:
      couplings spaced along the width of the side member, the couplings being configured to receive thereat corresponding couplings of the lifting machine; and
      attachment points comprising pipe engaging members spaced along the width of the side member, and
   a joining member between the side members, a length of the joining member being adjustable to define a separation between the side members which corresponds to a length of the pipes;
adjusting the length of the joining member to correspond to the length of the pipes, if necessary;
positioning the apparatus over the pipes;
engaging the pipe engaging members with the pipes; and
actuating the lifting machine to lift the apparatus and its dependent pipes (e.g. in order to carry them to another location).

In some embodiments of the methods of the present invention, the apparatus may be the apparatus of the first or second aspect of the present invention.

Other features, embodiments and advantages of the apparatus and method of the present invention will become apparent from the detailed description set out below.

### BRIEF DESCRIPTION OF DRAWINGS

Embodiments of the present invention will be described in further detail below with reference to the following drawings, in which:

FIG. 1 shows a perspective view of an apparatus in accordance with an embodiment of the present invention;

FIG. 2 shows a perspective view of the outer side of a side member of the apparatus of FIG. 1;

FIG. 3 shows an end view of the apparatus of FIG. 1;

FIG. 4 shows an exploded perspective view of the inner side of a side member of the apparatus of FIG. 1;

FIG. 5 shows top and side views of the apparatus of FIG. 1 in a contracted configuration;

FIG. 6 shows top and side views of the apparatus of FIG. 1 in an expanded configuration;

FIG. 7 shows the apparatus of FIG. 1 coupled to a crane and being used to carry eight relatively small pipes;

FIG. 8 shows the apparatus of FIG. 1 coupled to a reach stacker and being used to carry two relatively large pipes;

FIG. 9 shows a perspective view of the apparatus and reach stacker of FIG. 8;

FIG. 10 shows a close up view of the pipe engaging members of FIG. 9;

FIG. 11 shows a close up view of the apparatus of FIG. 1 being used with a reach stacker to carry eight relatively small pipes; and

FIG. 12 shows a perspective view of an apparatus in accordance with another embodiment of the present invention.

### DESCRIPTION OF EMBODIMENTS

The present invention provides apparatus and methods for carrying a plurality of elongate construction elements. In the context of the present invention, elongate construction elements are any elements used in construction and which are of a size that necessitates their lifting and carrying using specialised lifting machines. Examples of elongate construction elements include pipes, metal rods (e.g. merchant bars) and beams (metal and timber) having any shape. It will be appreciated that whist the apparatus is intended for use in carrying a plurality of elongate construction elements it could, of course, be used to carry a single construction element (e.g. a large pipe having a weight close to the apparatus' load limit).

In its broadest form, the apparatus comprises opposing side members and a joining member. Each of the side members is elongate in width and comprises one or more couplings and attachment points. The one or more couplings are configured to receive thereat corresponding couplings of a lifting machine. The attachment points are spaced along the width of the side member and configured to receive construction element engaging members thereat. The joining member is between the side members and has a length that is adjustable to define a separation between the side members which corresponds to a length of the construction element.

In its broadest form, the method comprises:
coupling a lifting machine to an apparatus that comprises:
   opposing side members, each side member being elongate in width and comprising:
      one or more couplings, each coupling being configured to receive thereat a corresponding coupling of the lifting machine; and
      attachment points comprising construction element (e.g. pipe) engaging members spaced along the width of the side member, and
   a joining member between the side members, a length of the joining member being adjustable to define a separation between the side members which corresponds to a length of the construction element (e.g. pipe);
adjusting the length of the joining member to correspond to the length of the construction elements (e.g. pipes), if necessary (either before or after coupling to the lifting machine); positioning the apparatus over the construction elements (e.g. pipes);
engaging the construction element engaging members with the construction elements (e.g. engaging pipe engaging members with opposing ends of the pipes); and
actuating the lifting machine to lift the apparatus and its dependent construction elements (e.g. pipes) and, if necessary, carry them to another location.

The apparatus and method of the present invention may be coupleable to any one or more lifting machines, including cranes, reach stackers and top lifting forklifts, which are examples of lifting machines commonly used in loading environments. For example, pipes may be unloaded from a cargo ship or from a road transport vehicle or rail wagon onto a dock (or a storage or distribution facility) using a crane but then subsequently carried to a storage location using a reach stacker or top lifting forklift. Providing an apparatus compatible for use with all of such lifting machines has the potential to significantly improve the overall efficiency of this process, both in respect of the time taken to load or unload the pipes (i.e. because it can carry more pipes, for example, than conventional lifting apparatus), but also because a reduced number of components are required to unload the pipes etc., which would help to simplify purchasing and maintenance requirements, for example.

Further, the apparatus of the present invention securely carries the construction elements at or near their ends providing a safer and more stable and secure attachment, and is readily liftable by travelling lifting machines which can be operated under any weather conditions.

The apparatus and method of the present invention may be used to carry any types of elongate construction elements, having any conventional form and structure. For simplicity, the apparatus and method of the present invention will generally be described below in the context of lifting and subsequently carrying pipes. It is to be appreciated, however, that the present invention is readily adaptable for lifting and carrying other construction elements such as steel rods, merchant bars, beams, etc.

The construction element engaging members used in the present invention may have any form capable of engaging with and holding the elongate construction elements at or near to their ends in a safe manner such that, when the apparatus is lifted, the construction elements are carried thereunder. Two examples of pipe engaging members, for example, contemplated by the inventors for use with the present invention include slings and pipe hooks, the operation of which will be described below in the context of specific embodiments. Other suitable pipe engaging members will be known to persons skilled in the art.

The components of the apparatus of the present invention (i.e. side members, joining member, etc.) may be formed from any suitable material or combination of materials. Given the intended uses for the apparatus, it is envisaged that strong metallic materials such as steel would typically be used to form the apparatus. The form of the apparatus and its components can be varied depending on the requirements of the apparatus for carrying a plurality of elongate construction elements (primarily the size and weight of the construction elements to be carried). In some embodiments, for example, structural components of the apparatus may be formed using universal beams and/or rectangular hollow sections.

The apparatus of the present invention includes opposing side members, each of which is elongate in width but may otherwise take any form which is suitable for the intended uses of the apparatus. Typically, the side members are substantially planar, with reinforcing used if necessary to increase their strength. For example, the double-walled box-type construction described below has been found by the inventors to be suitable for lifting up to eight pipes and loads of up to 30,000 kg.

The side members may have any appropriate shape, with simple shapes generally being preferred for ease of construction. Generally rectangular or trapezoidal (in cross section) shapes are likely to be the most appropriate, providing good stability and pipe carrying ability. However, generally triangularly-shaped or other shaped side members might be advantageous for some applications. As can be seen in the specific embodiments of the side members described in detail below, cut outs may be provided in order to reduce the weight of the side member and amount of material required to form it.

The side members may have any appropriate dimensions, depending primarily on the number and size of construction elements (e.g. pipes) to be carried, their weights and the coupling system of the lifting machine. In some embodiments, for example, the side members may have a width whereby up to eight pipes are carryable. By way of example, the side members described in further detail below have a height of up to about 1.6 m (from the corner casings to the support foot), a width of up to about 2.4 m and a thickness (wall to wall) of about 15 cm.

Each side member includes one or more couplings that are configured to receive thereat corresponding couplings of a lifting machine. The couplings may be appropriately configured, for example, because their shape, size, orientation and location on the side member/apparatus is compatible with the corresponding couplings of the lifting machine. The couplings may, in some embodiments, be configured such that they are compatible with the corresponding couplings of two or more lifting machines. Alternatively (or in addition), each side member may comprise two (or more) different types of couplings, in order to even further increase its versatility and adaptability in use (as is the case, for example, with the apparatus depicted in the figures and described in further detail below).

Typically, each side member will include two or more couplings which may, in some embodiments, be spaced along the width of each side member. The couplings may be located at any position on the side members, and would generally be located on an upper portion of the side members at (or proximal to) the opposing ends of the side members, both for enhanced stability and for compatibility with the couplings of some lifting machines. The couplings may, for example, be located at an uppermost position of the side members, in order to make them as accessible as possible for coupling to the lifting machine (as described below, for example), although this need not always be the case.

In embodiments having only one coupling on each side member, the couplings would usually be located substantially above the centre of gravity of the loaded apparatus (the couplings would usually be substantially centrally located on each of the side members).

The couplings may have form (e.g. shape, size and features), provided that they are coupleable to the lifting machine (possibly with the use of other components). The couplings may, for example, include a recess configured to receive a fastener of the lifting machine (e.g. in a female/male type fitting).

Given that one of the primary applications for the apparatus of the present invention is in a dock facility or in storage and distribution facilities, and that a reach stacker is one of the possible machines that may be used to lift the apparatus, a suitable coupling system is the twistlock and corner casting system used in practically all container carrying applications. In such embodiments, the couplings may be (or include) corner castings configured to receive twistlocks of the lifting machine (for example a respective twist lock of a spreader of the lifting machine). In effect, an apparatus having such couplings mimics the coupling configuration of a shipping container, which many lifting machines are already configured for coupling to. In alternative embodiments, the couplings themselves (i.e. those on the apparatus) may be provided with a twistlock (i.e. for coupling with a corner casting on the lifting machine), but this may overly complicate the apparatus, and lifting machines are usually provided having twistlocks and not corner castings.

Alternatively (or in addition), couplings of the apparatus may comprise a lift lug configured to receive a respective fastener (such as a D shackle) at an end of a chain, wire rope or the like. The other end of the chains (etc.) may be passed through the hook of a crane, with the apparatus and its dependent construction elements being lifted and moved by the crane in a more conventional manner.

In some embodiments, the one or more couplings may advantageously be configured for use with a plurality of coupling systems, for example, by having both a corner casting and fastenings (e.g. appropriately rated apertures) arranged in a configuration whereby the apparatus can be lifted by both a reach stacker and a crane in the manner described herein.

Each side member also includes attachment points which would usually be spaced along the width of the side member, and typically spread along the width of a lower portion of the side member, in order to best accommodate the construction elements to be carried by the apparatus. The attachment points are configured to receive construction element engaging members thereat. The attachment points may have any suitable form, provided that the construction element engaging members (described below) are attachable in a manner whereby construction elements can be lifted.

The attachment points may, for example, be provided in the form of apertures that are spread along the width of the side members, preferably close to a lower edge thereof in order to improve access to the apertures. The apertures may be evenly or unevenly spaced along the width of the side members, and a greater number of apertures than are actually required for any particular configuration of construction elements to be carried may be provided in order for the side members/apparatus to have the best possible adaptability for use with construction elements of varying sizes.

Fasteners, such as D shackles for example, may be passed through the apertures in order to attach chains, wire ropes or the like to the side members. Alternatively, chains (etc.) may be integrally provided in the attachment points for quicker deployment. As will be described below, the side members may also be configured to store (or at least keep out of the way) chains not being used during a particular construction element lifting operation.

A construction element engaging member is required in order to engage the construction element such that it/they are lifted when the lifting machine lifts the apparatus. Any suitable construction element engaging member may be used (many varieties are commercially available), depending primarily on the characteristics of the construction element to be carried (e.g. its form, weight, material of construction, diameter, etc.).

For example, pipe engaging members the inventors have found to be suitable for larger or more delicate pipes include slings that are configured to be wrapped around the pipe (i.e. at or near to each end of the pipe), with the ends of the slings being fastened to respective (typically spaced apart) attachment points (e.g. using a D shackle) on each of the opposing side members. Slings would also be suitable for engaging other kinds of construction elements such as rods or beams.

Pipe engaging members the inventors have found to be suitable for smaller or more durable pipes include pipe hooks of the type configured to hook opposing ends of a pipe, the hooks being at one end of a chain and the distal end of the chain being attached to the attachment point (i.e. as described above). Pipe hooks are known in the art, with numerous variations adapted for use with specific types of pipes being commercially available.

The apparatus of the present invention also includes a joining member between the side members. The joining member has a length that is adjustable to define a separation between the side members which corresponds to a length of the construction elements to be carried (typically, the construction element would be at least a little longer than the distance by which the side members are separated). The joining member may have any suitable form, but typically includes two separate members, each of which is joined to one of the side members. The joining member may be permanently attached to the side members, or may be attached using fasteners such as nuts and bolts so that the apparatus can be disassembled for ease of shipping.

In some embodiments, the joining member may include two overlapping members that are slidable relative to each other. Sliding one joining member with respect to the other changes the separation between the side members (from which the pipes will hang), and hence such movement results in a separation that is appropriate for the apparatus to carry construction elements having a given length. Once the side members are an appropriate distance apart, the joiners may be fastened together using any suitable fasteners. For example, the joining members may include a number of apertures along a length thereof, with the apertures of one joining member being alignable with those of the other joining member such that fasteners such as locking pins (at least two, but preferably three or more, depending on the degree of overlap) can be passed through the so-aligned apertures and secured.

In some embodiments, the joining member may comprise two members that are telescopically extendable. In some embodiments, a sleeve for the joining members may be provided, with the joining members being independently slidable into and out from the sleeve in order to adjust the separation between the side members.

The joining member may take any suitable form and may for example, be provided as beams having a suitable strength (e.g. I-beams). Thus, the joining member may include two overlapping beams. The joining member may have any appropriate dimensions (particularly its length or the lengths of its component members, which may be the same or different). By way of example, the joining members described in further detail below can be adjusted such that the side members are between about 6 and 13 m apart from each other.

The apparatus of the present invention may include other components, when those components may improve the functionality of the apparatus.

In some embodiments, for example, each side member may further comprise one or more ground engaging stands in order for the apparatus to sit in a preferred orientation when not in use and on the ground. Such an orientation may assist in raising the apparatus off what might be a muddy or wet surface in order to increase its longevity or convenience of use, or may simply facilitate a more straightforward coupling process with the lifting machine.

In some embodiments, the side members may comprise a recess or recesses in which chains or other construction element engaging members may be retained. When stored in such a manner, the chains (etc.) not currently in use can be held out of the way, where they will not interfere with any construction elements being carried (e.g. by banging against them) or present an operational risk (e.g. where a user is hit by a pipe engaging member swinging at the end of its chain).

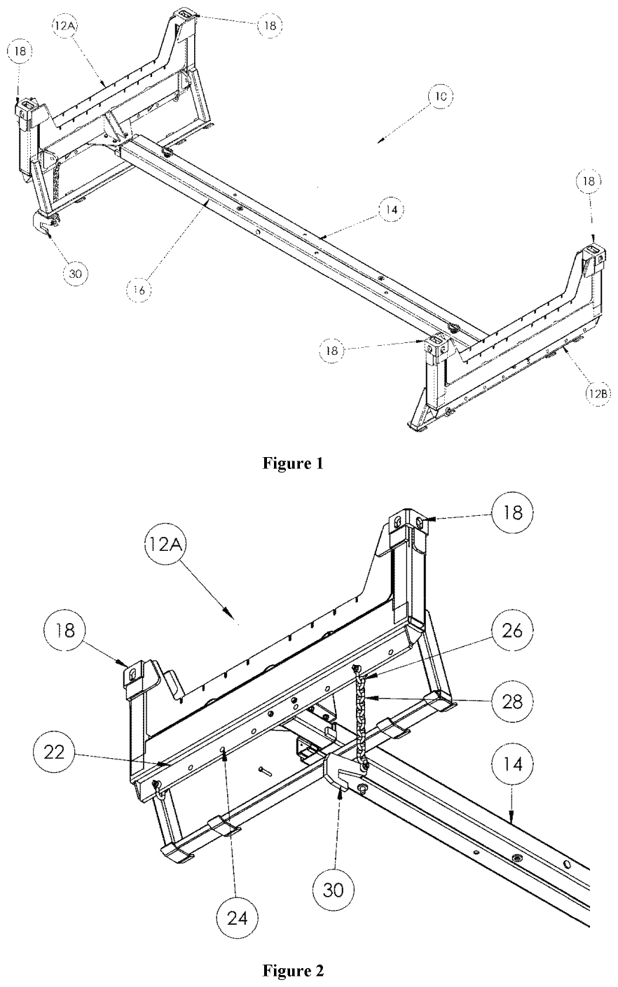

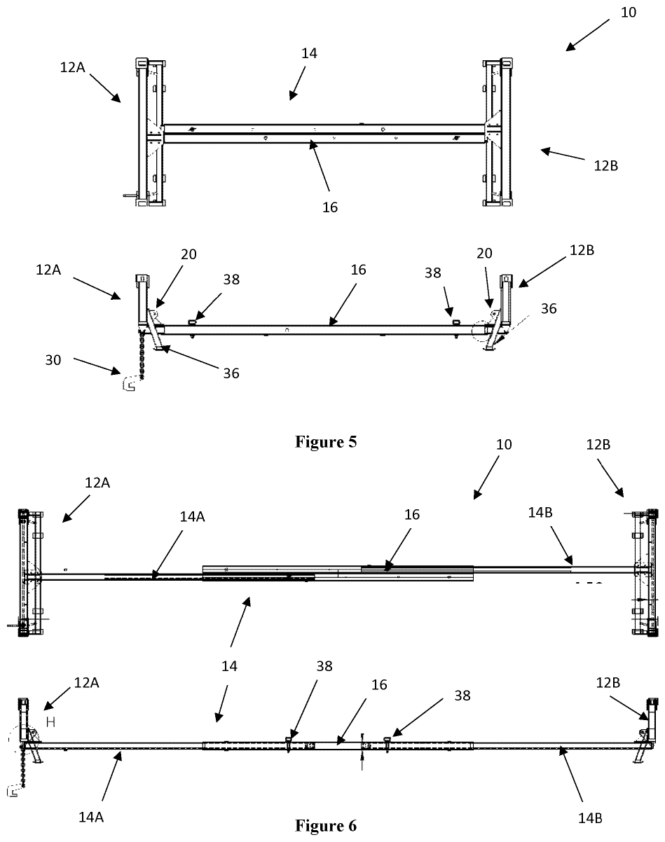

Referring now to the drawings, FIGS. 1 to 6 show an embodiment of an apparatus of the present invention in the form of pipe lifting frame 10. Frame 10 has side members 12A and 12B at opposing ends thereof, with side members 12A and 12B being joined by a joining member in the form of joiner 14. Joiner 14 itself includes two separate beams 14A and 14B (see FIG. 6), a portion of which are housed in sleeve 16.

Side members 12A and 12B are, in this embodiment, identical, so only side member 12A will be described in detail below. Side member 12A is elongate in its width, generally rectangular in shape and has a double walled construction (as can best be seen in FIGS. 2 and 4). In the embodiment shown, a rectangular hollow section construction is used, with the plates used to form the inner and outer walls of side member 12A being 25 mm thick steel plates, with all of the components being fully welded and plated in.

The opposing edges of side member 12A have, in uppermost locations, corner castings 18, 18 of the type typically found in shipping containers. Briefly, corner castings 18, 18 are each configured to receive therein a conventional twistlock (not shown) when the twistlock is in its first orientation. However, once the twistlock has been twisted into its second orientation (i.e. once inside corner casting 18), it is retained within the corner casting 18 and the lifting machine's twistlock therefore coupled to the corner casting.

The relative positioning of corner castings 18, 18, 18, 18 at the uppermost corners of the frame 10 (see FIG. 1) mimics that of conventional shipping containers and therefore enables reach stackers, top lift forklifts and the like (not shown), which are already configured to carry shipping containers to be able to carry frame 10 as well.

Side member 12A also has lifting lugs 20, 20 (see FIGS. 4 and 5), through which fasteners such as D-shackles (not shown) can be passed, with a chain or wire rope joining the D-shackle to a lifting machine (described below).

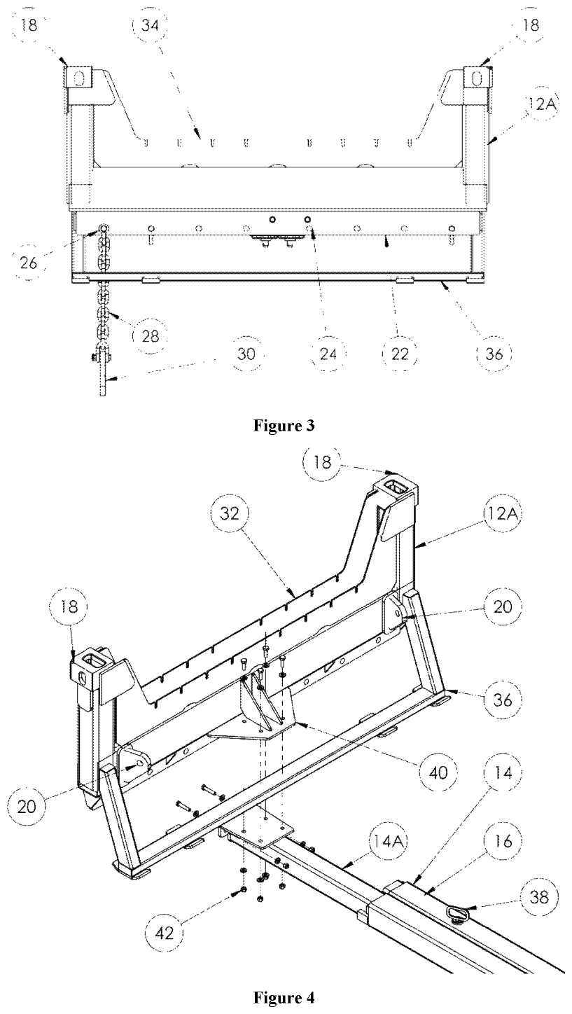

The lower portion of side member 12A includes a lug plate 22 (see FIGS. 2 and 3) which, in this embodiment, is a 25 mm thick single sheet of plate metal. Lug plate 22 has a number of apertures (eight, in this embodiment) shown generally at 24, evenly spaced therealong, with apertures 24 having a diameter suitable for receiving D shackles 26 (see FIG. 2) having a rating of 6.5 tonnes. D shackle 26 is attached to a chain 28, with the other end of chain 28 having a pipe hook 30. Only one D shackle 26, chain 28 and pipe hook 30 is shown in FIGS. 1 to 6 for clarity, but it will be appreciated that up to eight of these could be provided on side member 12A.

The cavity 32 defined between the inner and outer walls of side member 12A (see FIG. 4) may be used to store pipe hooks 30 and the portion of chains 28 which are not required for a particular lifting operation. Notches, shown generally as 34 (see FIGS. 3 and 4) may be provided for receiving a link of chain 28 in order to help prevent the (heavy) pipe hooks 30 from inadvertently falling out of cavity 32 (which might injure a person working near the frame 10). In some embodiments, cavity 32 may not need to be provided, depending on the intended uses of the frame.

Side member 12A also has a stand 36, which is configured to engage the ground (i.e. during storage of the frame 10) or an uppermost side of pipes (not shown) in order to appropriately locate the side members 12A, 12B for the operator to engage the pipe engaging members 30 with the pipes.

Frame 10 also includes a joiner 14, which joins side members 12A and 12B together. Joiner 14 has an effective length that is adjustable in order to adjust the separation of side members 12A and 12B. Joiner 14 includes two beams 14A and 14B (see FIGS. 5 and 6) and a sleeve 16, which has two adjacent channels into and out of which the beams 14A and 14B are slidable. Beams 14A and 14B are held in position with respect to sleeve 16 by locking pins, shown generally at 38, which can be passed through aligned apertures in the sleeve 16 and beams 14A or 14B, respectively.

Expansion and contraction of joiner 14 will now be described with reference to FIGS. 5 and 6. FIG. 5 depicts the narrowest configuration of frame 10, where beams 14A and 14B cannot be seen because they are almost completely inside of sleeve 16. In the embodiment shown, side members 12A, 12B have a separation of about 6 m whist the frame 10 is in this configuration (i.e. as shown in FIG. 5), and is hence configured for carrying pipes having a length of slightly more than 6 m (e.g. pipes having a length of about 7 m). If the frame 10 is required to carry longer pipes, then it will be necessary for it to be expanded. In order to do so, locking pins 38 would be removed and then one or both of beams 14A and 14B slid out of sleeve 16 until the side members 12A and 12B were the required distance apart (e.g. as shown in FIG. 6). Typically, beams 14A and 14B would be advanced out of sleeve 16 by around the same amount, but this need not always be the case. Once the side members 12A, 12B have the desired separation (i.e. slightly less than that of the pipes to be carried), the locking pins 38 would be passed through aligned apertures in beams 14A and 14B and sleeve 16 and secured. In the embodiment shown in FIG. 6, side members 12A, 12B have a separation of about 12 m whist the frame 10 is in this configuration, and the frame 10 thus configured for carrying pipes having a length of slightly more than 12 m (e.g. pipes having a length of about 14 m).

As can be seen in FIG. 4, beam 14A can be fastened to a plate 40 on the inner wall of side member 12A using fasteners shown generally as nuts and bolts 42. Providing the frame 10 in such an assemblable/dis-assemblable form would reduce the size of the frame 10 for shipping or other transport purposes.

Referring now to FIGS. 7 to 11, use of the frame 10 with lifting machines in the form of cranes 100 and reach stackers 110 and various coupling systems will now be described.

FIG. 7 shows a crane 100 lifting a frame 10 which is carrying eight relatively small pipes, shown generally at 102. Pipes 102 are suspended underneath frame 10 by slings, shown generally at 104, wrapped around opposite ends of the pipes 102. Each end of the sling 104 is fastened (e.g. via a D shackle) to the same aperture 24 in order for the sling to conform to a substantial portion of the outer surface of the pipe. Holding the pipes 102 at both ends in the manner described also helps to stabilise the pipes with respect to the frame 10, enabling its use in higher winds and over rougher terrain than is possible with conventional pipe carrying apparatus. In such a configuration, all of the apertures 24 on the frame 10 are being used to carry the pipes 102.

D shackles, shown generally at 106, are passed through the lifting lugs 20, 20, 20, 20 of frame 10, with chains, shown generally at 108 joining the frame 10 to the hook 109 of the crane 100. Operation of the crane 100 in the conventional manner can then result in the movement of up to 8 pipes (i.e. for frame 10) which, as will be appreciated, represents a significant increase in efficiency over conventional lifting systems, where only one or two pipes can usually be lifted at a time.

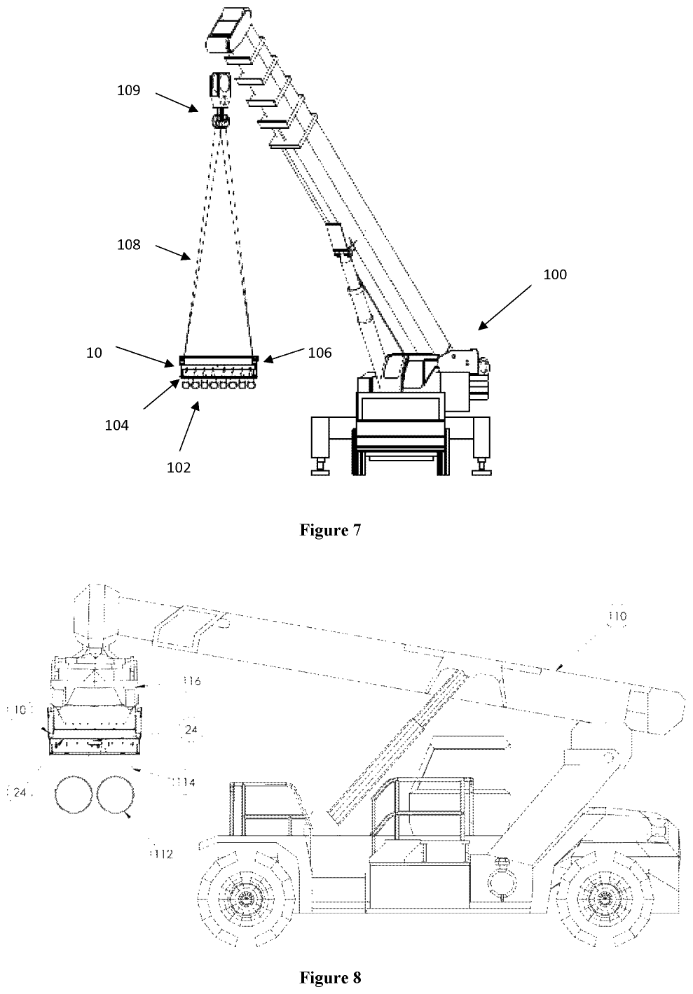

FIG. 8 shows a reach stacker 110 lifting a frame 10 which is carrying two relatively large pipes, shown generally at 112. Pipes 112 are suspended underneath frame 10 by slings, shown generally at 114, wrapped around opposite ends of the pipes 112, with the ends of each 114 sling being fastened (e.g. via a D shackle) to the separate apertures 24, 24. In such a configuration, not all of the apertures 24 on the frame 10 are used to carry the pipes 112, but the relative weight of the pipes 112 may be such that no additional pipes are able to be carried. As would be appreciated, the adaptability of frame 10 in being capable of carrying different numbers of differently sized and shaped pipes provides significant advantages.

Reach stacker 110 is coupled to frame 10 via its spreader 116. Although not shown, the underside of spreader 116 includes four twistlocks that are positioned and orientated for insertion into the corner castings 18, 18, 18, 18 of frame 10, whereupon twisting of the twistlocks securely couples the spreader 116 to the frame 10 in a conventional manner.

In a dockside embodiment (not shown), crane 100 could be used to lift pipes from the hold of a ship and transport them to the dock. Subsequently, reach stacker 110 could carry the pipes to their final destination (using the same frame or a different frame). As would be appreciated, reach stackers are capable of traversing rough terrain, so the present invention represents a significant improvement over existing pipe carrying techniques, both in respect of the number of pipes that are carryable, but also in respect of the ease by which they can be carried and the terrain over which they can be carried.

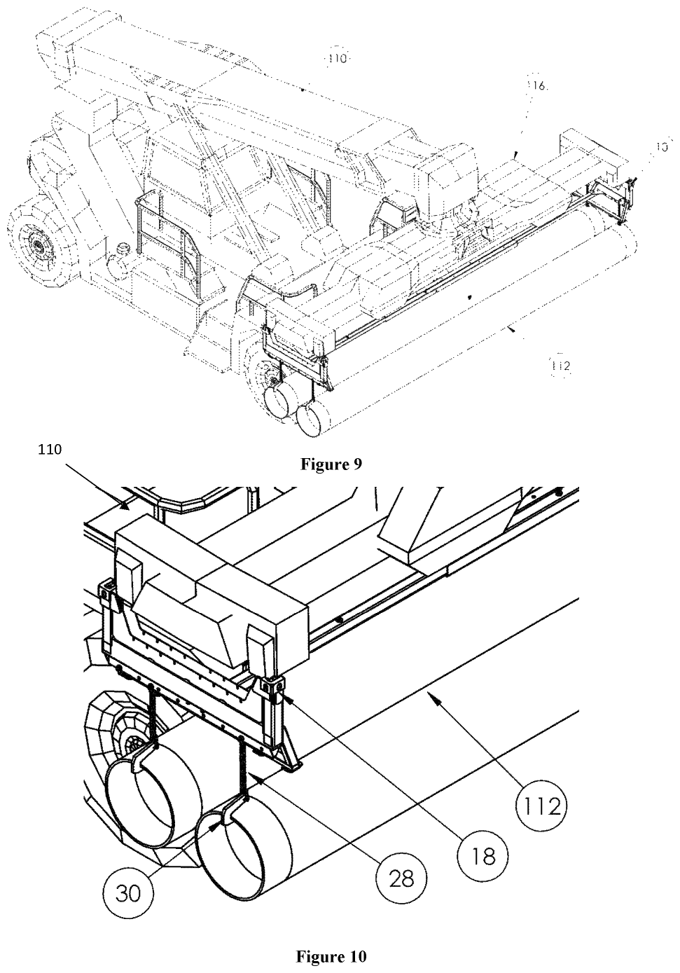

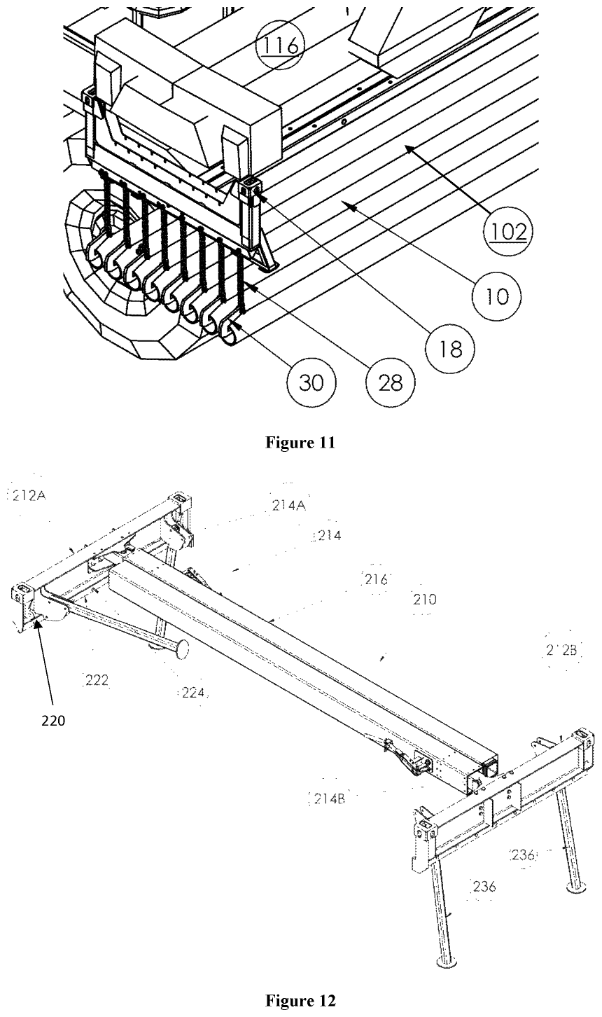

Referring now to FIGS. 9 to 11, reach stacker 110 is shown carrying relatively large pipes 112 (FIGS. 9 and 10) and relatively small pipes 102 (FIG. 11) in order to illustrate the easily adaptable nature of the frame 10. In these Figures, the pipes 102/112 are carried underneath the frame 10 using a pipe hook 30 and chain 28. In use, pipe hooks 30, 30 are positioned over the opposing edges of a pipe 102/112 and, upon lifting of the frame 10, the pipe hooks 30, 30 twist such that they securely grip the ends of the pipe. As the pipes 102/112 are slightly longer than the frame 10 (or at least the lug plates 22, 22 of the side members 12A, 12B), then the tension of the chains 28, 28 acts to securely retain the pipe 102/112 to the frame 10. As can be seen from the Figures, pipes having a variety of shapes are carryable using frame 10, which is itself advantageously compatible for use with a number of different kinds of lifting machines that are operable over different terrains.

Referring now to FIG. 12, show is another embodiment of an apparatus of the present invention in the form of pipe lifting frame 210. Similar to frame 10, frame 210 has side members 212A and 212B at opposing ends thereof, with side members 212A and 212B being formed from a universal beam instead of the rectangular hollow section of side members 12A and 12B. Side members 212A and 212B are joined by a joining member in the form of joiner 214. Joiner 214 itself includes two separate beams 214A and 214B which, in the drawing are completely housed within sleeve 216.

Side members 212A and 212B have lifting lugs 220, through which fasteners such as D-shackles (not shown) can be passed, with a chain or wire rope joining the D-shackle to a lifting machine (as described below). In the embodiment shown, the side members 212A and 212B do not have corner castings, but these could be provided if needed.

The lower portion of side members 212A and 212B includes a lug plate 222, which has a number of apertures, shown generally at 224, evenly spaced therealong. Similar to that described above, the apertures 224 have a diameter suitable for receiving D shackles (not shown), which can be attached (e.g. via a chain, not shown) to a construction element engaging member (e.g. a pipe hook, not shown). The side members 212A and 212B also have stands, shown generally as stand 236, which are configured to be foldable into a ground engaging position.

The beams 214A and 214B and sleeve 216 operate in a similar manner to that described above. It will be noted, however, that the ends of the beams 214A and 214B are attached to the I portion of the universal beam of the respective side members 212A and 212B. This configuration enables the sleeve 216 to be slightly longer than is the case for the sleeve 16, meaning that more of the beams 214A and 214B remain in the sleeve for a given extension, which helps to strengthen the apparatus.

It will be appreciated that the present invention provides a number of new and useful results. For example, specific embodiments of the present invention may provide one or more of the following advantages:
compatibility between a number of different types of lifting machines;
fewer components are required to lift and carry pipes;
a greater number of pipes may be carried than is the case for conventional pipe lifting apparatus, which may help to increase the efficiency of a pipe moving process;
carried pipes are more stably held with respect to the apparatus/lifting machine, enabling their use in a wide range of weather conditions (especially wind) and when travelling over relatively uneven terrain;
safety is greatly improved by securely holding the pipes at their ends and not in the middle, as is the case for many existing pipe lifting systems (where overbalancing may occur if the pipe is gripped off-centre);
fewer people may be required to operate the lifting machine(s) or handle the pipes;
lifting machines which can travel along the ground may be used (old pipe handling methods were often performed by non-travelling cranes and other lifting machines); and
the apparatus is easily adaptable in order to carry different numbers of differently sized and shaped pipes.

It will be understood to persons skilled in the art of the invention that many modifications may be made without departing from the spirit and scope of the invention. All such modifications are intended to fall within the scope of the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An apparatus for carrying a plurality of elongate construction elements, the apparatus comprising:
opposing side members, each side member being elongate in width and comprising:
one or more couplings configured to receive thereat corresponding couplings of a lifting machine; and
attachment points spaced along the width of the side member, the attachment points being configured to receive construction element engaging members thereat, and
a joining member between the side members, a length of the joining member being adjustable to define a separation between the side members which corresponds to a length of the construction elements.

2. The apparatus of claim 1, wherein the one or more couplings comprise couplings spaced along the width of each side member.

3. The apparatus of claim 2, wherein the couplings are located at opposing ends of each side member.

4. The apparatus of any one of claims 1 to 3, wherein the one or more couplings each comprise a recess configured to receive a fastener of the lifting machine.

5. The apparatus of any one of claims 1 to 4, wherein the one or more couplings each comprise a corner casting configured to receive a twistlock of the lifting machine.

6. The apparatus of claim 5, wherein the one or more couplings are configured to receive a respective twistlock of a spreader of the lifting machine.

7. The apparatus of claim 5 or claim 6, wherein the one or more couplings are configured to receive a respective twistlock of a spreader of a reach stacker or top lifting forklift.

8. The apparatus of any one of claims 1 to 4, wherein the one or more couplings each comprise a lift lug configured to receive a respective fastener at an end of a chain.

9. The apparatus of claim 8, wherein the fastener is a D-shackle.

10. The apparatus of any one of claims 1 to 9, wherein the attachment points are spaced along the width of a lower portion of each side member.

11. The apparatus of any one of claims 1 to 10, wherein the attachment points comprise apertures spread along the width of each side member.

12. The apparatus of any one of claims 1 to 11, wherein the construction element engaging members comprise slings configured to be wrapped around a construction element, each end of the slings being fastenable to an attachment point.

13. The apparatus of any one of claims 1 to 11, wherein the construction element is a pipe and the construction element engaging members comprise hooks configured to hook opposing ends of the pipe, the hooks being at one end of a chain and the distal end of the chain being attached to the attachment point.

14. The apparatus of any one of claims 1 to 13, wherein the side members are substantially planar.

15. The apparatus of any one of claims 1 to 14, wherein the joining member comprises two overlapping members that are slidable relative to each other.

16. The apparatus of any one of claims 1 to 15, wherein the joining member comprises two members that are telescopically extendable.

17. The apparatus of any one of claims 1 to 16, wherein each side member further comprises a ground engaging stand.

18. The apparatus of any one of claims 1 to 17, wherein the plurality of construction elements are pipes, rods or beams.

19. A method for carrying a plurality of pipes, the method comprising:
coupling a lifting machine to an apparatus comprising:
opposing side members, each side member being elongate in width and comprising:
one or more couplings, each coupling being configured to receive thereat a corresponding coupling of the lifting machine; and
attachment points comprising pipe engaging members spaced along the width of the side member, and
a joining member between the side members, a length of the joining member being adjustable to define a separation between the side members which corresponds to a length of the pipes;
adjusting the length of the joining member to correspond to the length of the pipes, if necessary;
positioning the apparatus over the pipes;
engaging the pipe engaging members with a respective pipe of the pipes; and
actuating the lifting machine to lift the apparatus and its dependent pipes.

20. The method of claim 19, wherein the apparatus is the apparatus of any one of claims 1 to 18.
